(19) United States
(12) Patent Application Publication
(10) Pub. No.: US 2008/0178029 A1
(43) Pub. Date: Jul. 24, 2008

(54) Using priorities to select power usage for multiple devices

(75) Inventors: Sean Nicholas McGrane, Sammamish, WA (US); John M. Parchem, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/655,956

(22) Filed: Jan. 19, 2007

(51) Int. Cl. G06F 1/32

(52) U.S. Cl. 713/324; 713/320

(57) ABSTRACT

Aspects of the subject matter described herein relate to using priorities to select power usage for multiple devices. In aspects, workloads or the devices to which they are assigned are each assigned a priority. To remain within a power budget, the power levels on one or more of the devices may be adjusted based on the priority assigned to the device (or a workload thereon). If needed, devices may be instructed to operate at lower power than associated with their priority or may even be shut down to remain within the budget. A data structure is used to associate workloads or devices with priorities.

### BACKGROUND

A data center may include racks of servers, networking equipment, and other electronic devices. To determine how many devices a data center may handle, a power rating value of the power supply unit of each device may be used. This value is referred to as ‘label power’ and is typically much higher than the maximum power the particular device could ever draw. Using the ‘label power’ results in budgeting too much power for each device, and, as a result, servers may be populated more sparsely than they need to be. Data center floor space is very expensive and this under-utilization has a negative effect on the total cost of ownership for the data center.

### SUMMARY

Briefly, aspects of the subject matter described herein relate to using priorities to select power usage for multiple devices. In aspects, workloads or the devices to which they are assigned are each assigned a priority. To remain within a power budget, the power levels on one or more of the devices may be adjusted based on the priority assigned to the device (or a workload thereon). If needed, devices may be instructed to operate at lower power than associated with their priority or may even be shut down to remain within the budget. A data structure is used to associate workloads or devices with priorities.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” should be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram of an exemplary system in which aspects of the subject matter described herein may operate;

FIG. 3 illustrates exemplary power data structures that may be used in accordance with aspects of the subject matter described herein;

FIG. 4 illustrates exemplary priorities data structures that may be used in accordance with aspects of the subject matter described herein; and

FIGS. 5A and 5B are a flow diagram that generally represents exemplary actions that may occur in allocating power based on priorities in according with aspects of the subject matter described herein.

### DETAILED DESCRIPTION

### Exemplary Operating Environment

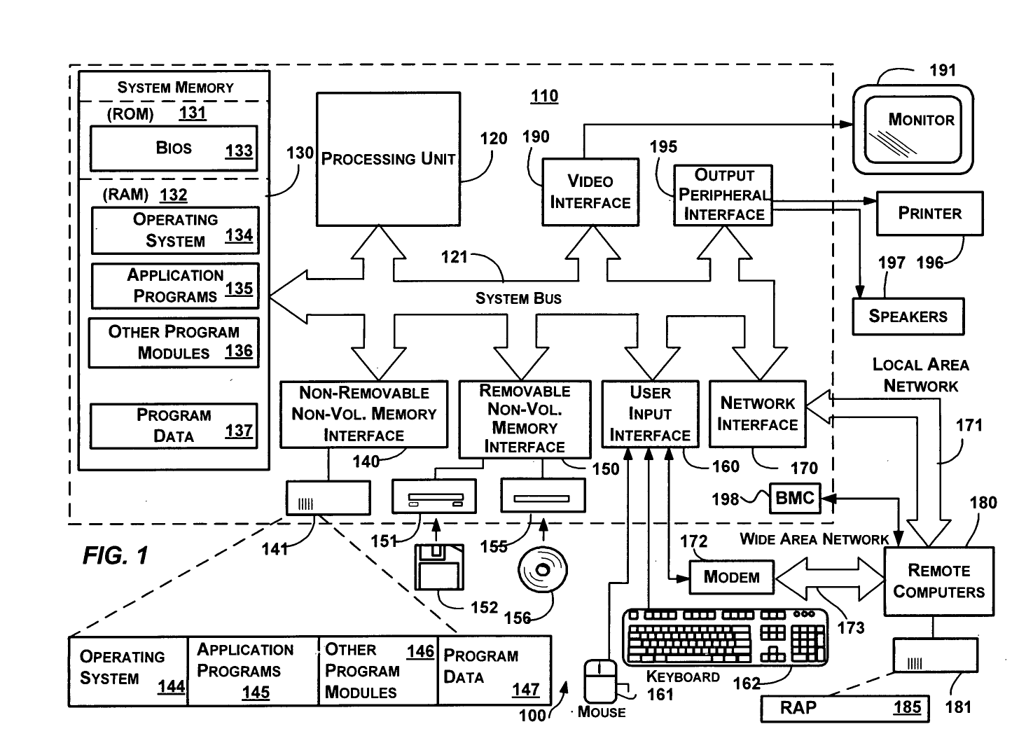

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

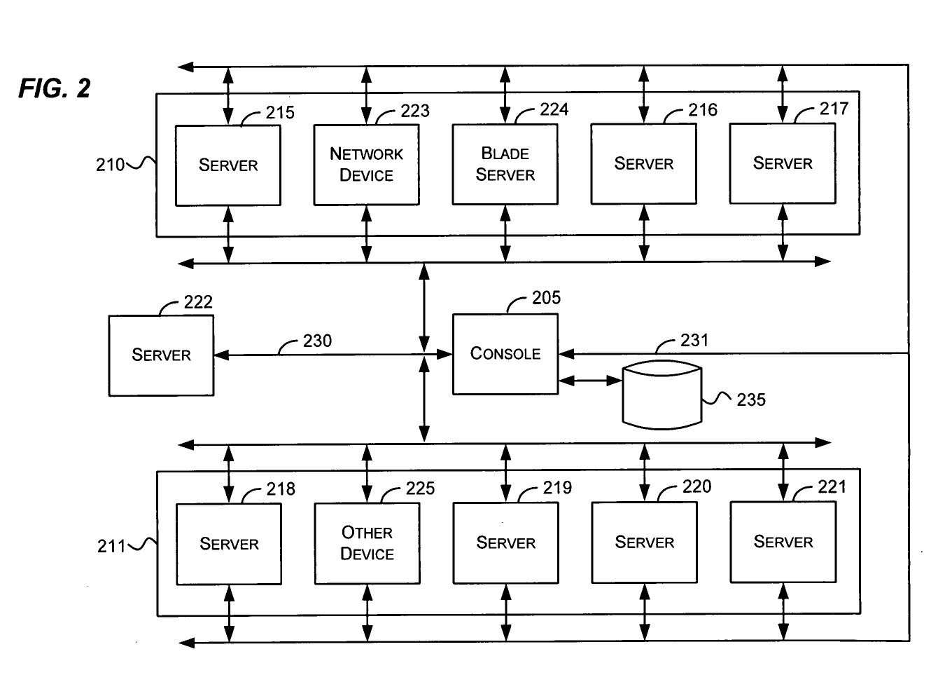

A baseboard management controller (e.g., BMC 198) may be embedded on the computer 110 to allow the computer 110 to communicate with other devices out-of-band (e.g., without using an operating system). The BMC 198 may be able to report temperature, cooling fan speeds, power mode, operating system status, and the like to a console (such as console 205 of FIG. 2). The BMC 198 may include a processor that is capable of operating at a very low power draw when other components of the computer 110 are turned off. In addition, the BMC 198 may communicate what power capabilities the computer 110 has and may be able to set the power level of the computer 110. Power capabilities include the different power level(s) at which the computer 110 is able to operate.

### Server Priorities and Power Budgeting

A data center may include many servers and electronic devices as shown in FIG. 2. The data center needs to be able to supply enough power to the devices and also needs to be able to have enough cooling capacity to keep the devices at a safe operating temperature. Many of the devices in a data center may be mounted in racks while other of the devices may be free-standing. Each rack may be assigned a particular power budget. For correct operation, the combined power consumed by the devices in a rack should not exceed its assigned power budget. Doing so may cause a breaker to trip or may cause too much heat which may adversely affect other components in the rack or in other racks.

In one embodiment, when there are not enough devices on a rack to exceed the power budget assigned to a rack, each device may run at its maximum power level. If more devices are introduced to the rack or if a lower power budget is assigned, however, the devices may exceed the power budget assigned to the rack if they are allowed to run at maximum power. In this case, in accordance with aspects of the subject matter described herein, server priorities may be used to assign power levels to each of the devices in the rack so as to not exceed the power budget assigned to the rack. These aspects as described herein may also be applied to any arbitrary set of devices from as few as one device up to and including all the devices in the data center.

FIG. 2 is a block diagram of an exemplary system in which aspects of the subject matter described herein may operate. The system includes a console 205 (e.g., a central management console), racks 210-211, devices 215-225, and communication channels 230-231.

The devices 215-225 may include servers (e.g., servers 215-222), network devices (e.g., network device 223), blade servers (e.g., blade server 225), and other devices (e.g., other device 225). The rack 210 houses the servers 215-217, the network device 223, and the blade server 225 while the rack 211 houses the servers 218-221 and the other device 225. The server 222 may be free-standing and may be located outside of a rack. An exemplary device that may be used as a server such as one of servers 215-222 is the computer 110 of FIG. 1 configured with appropriate hardware and software. A data center may have more or fewer devices like the ones represented in FIG. 2.

The communication channel 230 may include one or more networks that connect the devices 215-225 to the console 205 and to other devices and or networks such as the Internet (not shown). A suitable networking protocol such as the TCP/IP protocol, token ring protocol, or some other network protocol may be used to communicate via the communication channel 230.

The communication channel 231 may comprise a network, point-to-point links (e.g., serial connections), or other communication link that allows communication with the devices 215-225 “out-of-band.” Out-of-band in this sense refers to being able to communicate with the devices without regard to the operating system on the devices 215-225.

In one embodiment, a baseboard management controller (BMC) may be embedded on a device to allow the console 205 to communicate with the device out-of-band. An exemplary BMC (e.g., BMC 198) is described in conjunction with FIG. 1. As described previously, the BMC may be able to report temperature, cooling fan speeds, power mode, operating system status, and the like to the console 205. In addition, the BMC may communicate what power capabilities its corresponding device has. Power capabilities include the different power level(s) at which a device is able to operate.

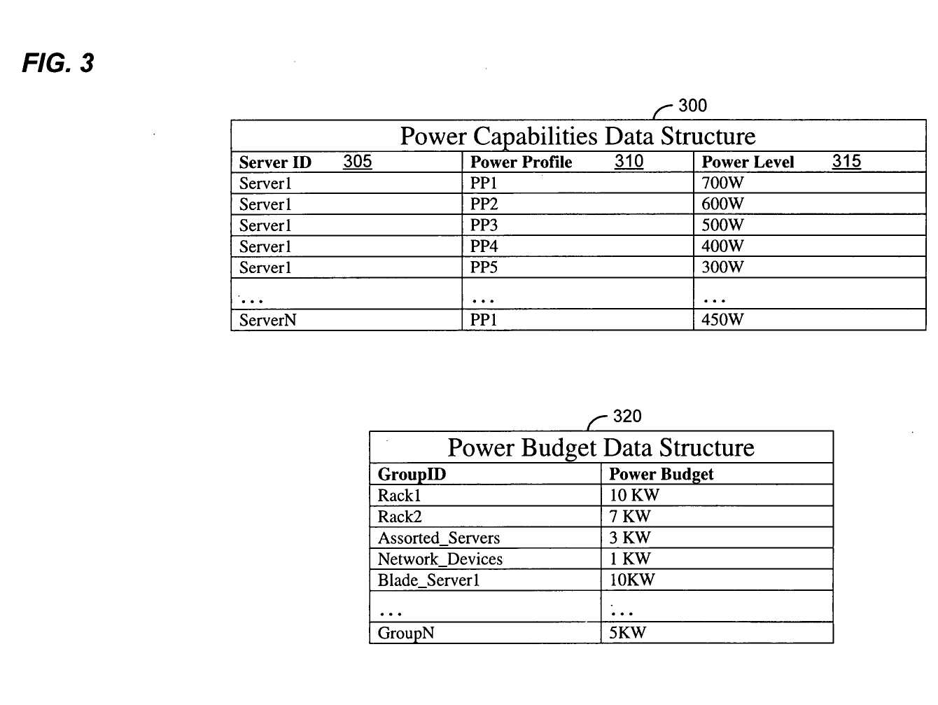

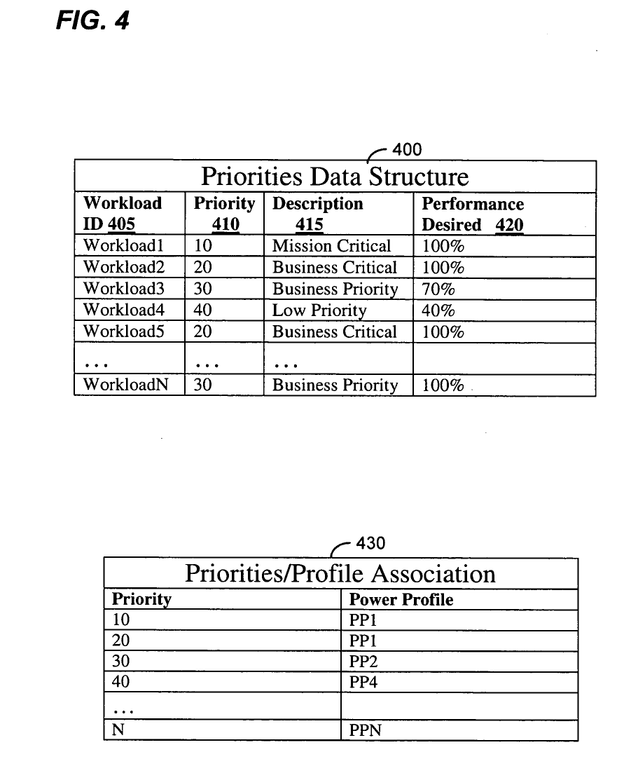

The console 205 may store these power capabilities and priority data in one or more data structures located on a storage device 235. The storage device 235 may comprise computer-readable media such as the computer-readable media described in conjunction with FIG. 1, for example. Some exemplary formats of these data structures are described in more detail in conjunction with FIGS. 3 and 4. In general, the one or more data structures (hereinafter sometimes referred to simply as “the data structure”) includes the various power level(s) at which each device is capable of operating and includes a way of identifying the device associated with each power level. In addition, the data structure may associate a location (e.g., rack) with each device. The data structure may also include a power budget that is associated with a set of devices. These set of devices may be physically collocated (e.g., in a single rack), or may be spread throughout a data center. The data structure may also associate workloads with priorities and priorities with power profiles.

In one embodiment, the data structure does not include information regarding how the devices are able to implement a power level. For example, the data structure may not include what components a device powers on or off or places in an increased or reduced power state to achieve a power level. Instead, the data structure may simply include the power levels at which the device is capable of operating. In other words, the details of which components are running in which power modes on a particular server may be transparent to a console using the data structure.

In this embodiment, omitting power information about components of each device provides flexibility to describe new power levels that may be introduced in the future. For example, a data structure that was structured to obtain power information about a pre-determined set of hardware may not work properly if new hardware is developed. In addition, having the device determine which components to place in a different power state based on a console commanded power level allows device manufacturers to cause their devices to operate within certain tested configurations.

Using the data structure, the power management software on the console 205 (or on any other machine capable of accessing the storage device 235) may accurately determine how much power is needed by a set of devices and how much power from a budget is remaining for a set of devices. Where location information is included, the power management software may determine whether additional devices may be added to a set of devices (e.g., on a rack) and still consume less power than the power budget allocated to the set of devices.

A device may be instructed to operate at a supported power level by sending a command to the device to operate at the power level. In one embodiment, if the device is under control of an operating system, this may be done through the communication channel 230 by communicating with the operating system (or software executing thereon). In another embodiment, this may be done out-of-band via the communication channel 231 regardless of whether the device is under control of an operating system. When the device receives the command, it determines which components to power on or off or to reduce or increase in power consumption to meet the power level specified by the command. For example, when operating above its minimum power consumption, a CPU may be instructed to decrease its power consumption.

FIG. 3 illustrates exemplary power data structures that may be used in accordance with aspects of the subject matter described herein. The power capabilities data structure 300 includes a server ID field 305, a power profile field 310, and a power level field 315. The power level field 315 indicates a maximum power that the device may consume when assigned to its associated power profile. The server ID field 305 includes entries that associate the power levels with devices. These entries may include unique identifiers that identify the devices.

In one embodiment, data may be stored that indicates the power profile that is active on each of the devices. This data may then be used for budgeting power or otherwise without re-querying the devices to obtain the power profiles.

In one embodiment, the power profile field 310 may be omitted from the power capabilities data structure 300. In this embodiment, a device may be instructed to operate at a power no greater than a particular power level by sending the power level to the device.

In one embodiment, having a device “operate at” a particular power level does not mean that the device is required to use the power of the particular power level. Rather, it means that the device may use any power that does not exceed the particular power level. For example, if the work a device is doing is reduced, the device may determine to draw less power until more work is given to the device.

The power capabilities data structure 300 includes an entry for each power level of each device for which power budgeting is desired. In another embodiment, another field may be added to the power capabilities data structure 300 that includes a location (e.g., rack number, physical location as indicated, for example, by coordinates, etc.) or grouping of devices that are affected by a common power budget. This field may be used in conjunction with a power budget data structure 320 to allocate power to each device in the group.

FIG. 4 illustrates exemplary priorities data structures that may be used in accordance with aspects of the subject matter described herein. In one embodiment, the priorities data structure 400 may include one or more items (e.g., rows) that each include a workload ID field 405, a priority field 410, a description field 415, and a performance desired field 420. In another embodiment, the priorities data structure 400 may include one or more items that include a workload ID field 405 and a priority field 410 while another data structure may be used to associate the priority field with the description and performance desired fields. In yet another embodiment, the description field 415 and/or performance desired field 420 may be omitted altogether.

Workloads may be associated with servers in many different ways. For example, when a workload corresponds to all the processes that execute on a single server, the workload ID field 405 may simply include the server ID. As another example, a data structure that explicitly maps workloads to servers may be employed to associate workloads to servers. Other mechanisms may also be used without departing from the spirit or scope of aspects of the subject matter described herein.

A value in the workload ID field 405 serves to identify a workload associated with the priority included in the priority field 410. In one embodiment, a workload corresponds to the processes that execute on a single server. In one embodiment, the single server is a physical server. In another embodiment, the single server is a virtual server. In virtual server embodiments, a workload may correspond to all the processes that execute in the virtual server environment for a single virtual server or the workload may correspond to all the processes that execute on a physical machine (which may include more than one virtual server). In embodiments where a physical machine hosts multiple virtual servers and each virtual server is assigned a priority or where a physical machine is assigned several workloads that are each assigned a priority, the priorities may be combined in some fashion to generate a priority that applies to the physical machine.

If a workload is migrated from one machine to another, the workload ID may still be used to identify the workload and associate a priority with it.

In another embodiment, a workload ID corresponds to a physical server ID. In this embodiment, the workload ID identifies the physical server (and may be thought of as a server ID). If a workload is moved to another physical server, the priority associated with the other physical server may be changed to correspond to the priority of the moving workload.

A workload may also be thought of as a server role. For example, a server may be considered an e-mail server, a web server, a database server, a financial server, a file server, a network server, a print server, a directory server, and the like. As such, a server role may be associated with a priority such that each server fulfilling the server role is assigned the priority.

A priority may be assigned to a workload through various mechanisms. In one embodiment, a workload may be assigned a priority through input received from a user interface. This may be done during deployment, for example. In another embodiment, a workload may be assigned a priority through a manifest that accompanies that workload. A manifest may include the hardware and software needed for a workload as well as the priority. In yet another embodiment, a workload may be assigned a priority via a script or some automated process.

The priority field 410 includes relative power priorities for the identified workloads. In one embodiment, a priority with a lower number has a higher priority than a priority with a higher number. In another embodiment, this may be reversed.

Some workloads are critical to a company's success. Slowing these workloads (e.g., by reducing power to the servers tasked with the workloads) may dramatically decrease a company's profitability or viability. Such workloads may need all the performance capability of the servers upon which they execute. Such workloads may be assigned a high priority. This is represented by the description “Mission Critical” in a description field. Other priorities may have different descriptions associated with them such as “Business Critical,” “Business Priority,” “Low Priority,” and so forth. Indeed, more, fewer, and/or different descriptions may be associated with priorities without departing from the spirit or scope of aspects of the subject matter described herein. Furthermore, as mentioned previously, descriptions of priorities may be entirely omitted without departing from the spirit or scope of aspects of the subject matter described herein.

Descriptions may be used to help a system administrator assign priorities to workloads. For example, a user interface may display the descriptions and allow the system administrator to select one of the descriptions from a drop down text box. Selecting one of the descriptions may cause the priority associated with the description to be assigned to the workload.

In one embodiment, the priority values corresponding to different power profiles are not sequential. This may be done to allow additional priorities to be inserted between two currently existing priorities without renumbering all existing priorities.

The performance desired field 420 may indicate a desired performance of the server upon which the workload is placed. In one embodiment, the performance desired field 420 corresponds to the closest power capability of the server that consumes a percentage at or above the performance desired percentage. For example, if the performance desired is 70% and a server has power capabilities of 1 kilowatt, 800 watts, 600 watts, and 500 watts, the 800 watt performance capability would correspond to the performance desired. In another embodiment, if performance is quantified in other terms (e.g., CPU speed, disk throughput, networking capacity, main memory, etc.), the power capability that provides the desired performance corresponds to the performance desired.

In one embodiment, a data structure such as the priorities/profile data structure 430 may be used to associate priorities with power profiles. The priorities/profile data structure 430 may be used instead of a performance desired field 420 to explicitly associate priorities with power profiles. A priority that is not found in the priorities/profile data structure 430 may be associated with a power profile of the priority that is just higher or just lower than the priority. For example, if a workload has a priority of 25, the priority may be associated with the PP1 or the PP2 profile.

In one embodiment, a power budget may be applied to a collection of devices based on their priorities (or the priorities of the workloads assigned to the devices) without using the performance desired field 420 or an explicit association such as shown in the priorities/profile data structure 430. In this embodiment, the budgeted power is allotted to the various devices based on their relative priority. If there is not enough power for all of the devices to run at maximum power, the power levels for each device is determined using its priority level relative to other devices.

The titles of each field and the title of the data structure described herein are optional and need not be stored in the data structure or elsewhere.

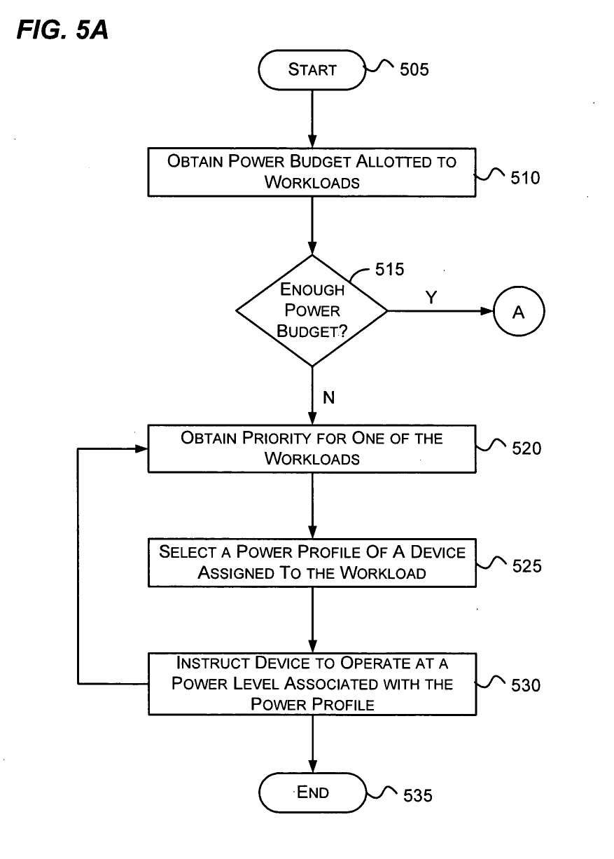

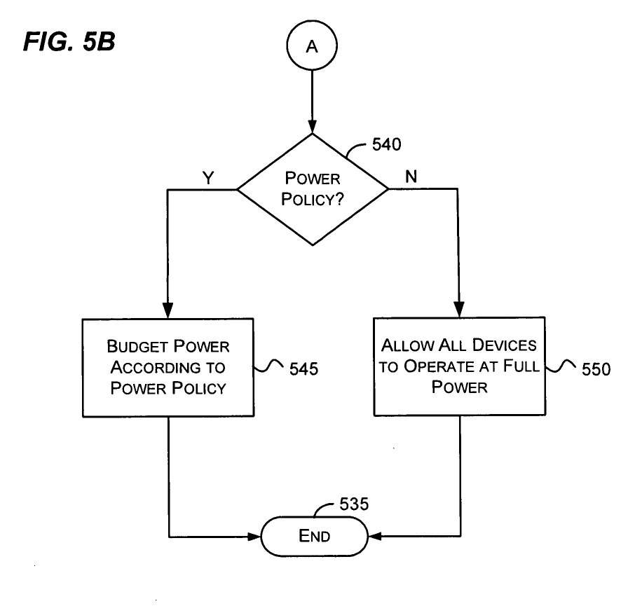

FIGS. 5A and 5B are a flow diagram that generally represents exemplary actions that may occur in allocating power based on priorities in according with aspects of the subject matter described herein. The actions described below may occur, for example, when applying a power budget to a collection of devices. This may happen when the collection of devices is initially assigned the power budget or when the power budget is changed, for example. At block 505, the actions begin.

At block 510, a power budget for a set of workloads is obtained. The workloads may be performed by a set of devices. In one embodiment, there is a one to one correspondence between workloads and devices. In another embodiment, more than one workload may execute on a device. For example, referring to FIG. 2, the console 205 may obtain the power budget for the workloads for the devices housed in rack 210.

At block 515, a determination is made as to whether the power budget is sufficient for the devices that perform the workloads to run at full power. If so, the actions continue at block 540; otherwise, the actions continue at block 520. For example, referring to FIGS. 2 and 3, the console 205 may use the power capabilities data structure 300 and the power budget data structure 320 to determine whether there is enough power budgeted to the workloads for the devices to operate at full power.

At block 520, a priority for at least one of the workloads is obtained. For example, referring to FIGS. 2 and 4, the console 205 retrieves the priorities data structure 400 from the storage device 235. The console 205 then obtains a priority associated with one of the workloads. In one embodiment, the workload with the lowest priority is selected first. In another embodiment, a workload with a different priority is selected.

At block 525, a power profile of a device assigned to the workload is selected or determined. If a device that is assigned to the workload is operating at a higher power level than associated with the priority of the workload, the power profile associated with the priority of the workload may be selected.

At block 530, the device is instructed to operate at a power level associated with the power profile. For example, referring to FIG. 2, the console 205 may instruct the server 215 to operate at 500 watts instead of full power.

If the power consumed by the devices does not exceed the power budget, the actions continue at block 535; otherwise, the actions may continue at block 520 to set the power level of another of the devices.

If the power budget is exceeded even after reducing all devices to the power levels associated with their workloads, many different actions may occur without departing from the spirit or scope of aspects of the subject matter described herein. For example, a warning may be displayed or sent to a system administrator indicating that the power budget has or may be exceeded by the devices.

As another example, further power savings may occur by reducing the power levels of the devices even further, if possible. This may occur in many different ways. For example, each of the devices (starting with lowest priorities) may be reduced a power level (if possible) until the power budget is not exceeded or until all devices are set to operate at their lowest power level.

If the power that may be consumed by the devices still exceeds the power budget, some of the devices may be powered down. Powering down devices may also be done by priorities where lower priority devices are powered down before higher priority devices. Powering down devices may also be done in some other manner.

It will be recognized that system administrators may desire many different actions to occur if a power budget is or may potentially be exceeded. These actions may be defined in a power policy, by computer code, rules, or otherwise, without departing from the spirit or scope of aspects of the subject matter described herein.

Turning to FIG. 5B, at block 540, a determination is made as to whether a power policy applies to allowing devices to operate at full power when enough power is available for all devices to operate at full power. For example, a policy may indicate that devices are to operate at power levels budgeted to their workloads, even if enough power is available in a power budget to operate all devices at full power. If a power policy applies, the actions continue at block 545; otherwise, the actions continue at block 550.

At block 545, power is budgeted to the devices according to the power policy that applies.

At block 550, the devices are allowed to operate at full power.

At block 535, the actions end.

As can be seen from the foregoing detailed description, aspects have been described related to using priorities to select power usage for multiple devices. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A computer-readable medium having computer-executable instructions, which when executed perform actions, comprising:
obtaining a power budget for a plurality of workloads, the workloads being assigned to devices, the power budget indicating a maximum power that the devices together are allowed to consume;
obtaining a priority for a workload;
based at least in part on the priority, selecting a power profile for a device assigned to the workload; and
instructing the device to operate at a power level associated with the power profile.

2. The computer-readable medium of claim 1, wherein the devices are housed in a rack and wherein the power budget applies to workloads assigned to devices in the rack.

3. The computer-readable medium of claim 2, wherein the power budget is less than power that the rack is capable of supplying.

4. The computer-readable medium of claim 1, wherein selecting a power profile for a device based at least in part on the priority comprises retrieving an association between the power profile and the priority from a data structure that associates priorities with power profiles.

5. The computer-readable medium of claim 1, wherein power levels at which the devices are capable of operating are stored by a console device that is used in part to manage power to the devices and wherein instructing the device to operate at a power level associated with the power profile comprises the console device instructing the device to operate at the power level.

6. The computer-readable medium of claim 1, wherein each of the devices is assigned to one workload and wherein no device is assigned to more than one workload.

7. The computer-readable medium of claim 1, wherein at least one device is assigned to more than one workload.

8. The computer-readable medium of claim 1, further comprising:
obtaining a priority of another workload;
based at least part on the priority of the other workload, selecting a power profile for a device assigned to the other workload; and
instructing the device assigned to the other workload to operate at a power level associated with the power profile for the device assigned to the other workload.

9. The computer-readable medium of claim 1, wherein instructing the device to operate at a power level associated with the power profile comprises providing an indication of the power profile to the device, the device being configured to consume less or equal power than the power level associated with the power profile in response to receiving the indication.

10. The computer-readable medium of claim 1, wherein instructing the device to operate at a power level associated with the power profile comprises sending an indication of performance desired to the device.

11. The computer-readable medium of claim 10, wherein the indication is a percentage that indicates a percentage of a maximum power the device is capable of consuming.

12. A method implemented at least in part by a computer, the method comprising:
obtaining a power budget for a plurality of devices, the devices being associated with priorities, each device being associated with a power priority;
determining whether the power budget is greater than the power consumed by the devices when operating at full power;
if the power budget is greater than the power consumed by the devices when each device is operating at full power, determining whether to allow the devices to operate at full power; and
if the power budget is not greater than the power consumed by the devices when each device is operating at full power, instructing at least one of the devices to operate at a power level less than full power based at least in part on the power priority associated with the device.

13. The method of claim 12, wherein determining whether to allow the devices to operate at full power comprises applying a policy.

14. The method of claim 12, wherein determining whether to allow the devices to operate at full power comprises allowing the devices to operate at full power if no policy applies.

15. The method of claim 12, further comprising if the power budget is not greater than the power consumed by the devices when each device is operating at a power level associated with the power level associated with the device, instructing at least one of the devices to operate at a power level less than the power level associated with the power priority associated with the at least one of the devices.

16. The method of claim 12, further comprising if the power budget is not greater than the power consumed by the devices when each device is operating at a minimum power level associated with the device, instructing at least one of the devices to shut down.

17. A computer-readable medium having stored thereon a data structure, comprising:
a plurality of first fields for storing priorities of a plurality of devices assigned to workloads that are allotted a power budget over which a combined power draw of the devices is not to exceed, each power level indicating a maximum power a devices assigned to a workload is not to exceed at the power level; and
a plurality of second fields for storing associations between the power profiles and priorities, each priority being associated with at least one of the power profiles

18. The computer-readable medium of claim 17, further comprising a plurality of third fields for storing associations between the priorities and the workloads, the third fields including identifiers that identifying workloads.

19. The computer-readable medium of claim 17, further comprising a plurality of third fields for storing performance desired for each of the workloads, each performance desired field relating to a power level of a device assigned to one of the workloads.

20. The computer-readable medium of claim 17, wherein the priorities are relative with respect to the workloads.
